(19) United States
(12) Patent Application Publication
(10) Pub. No.: US 2026/0257126 A1
(43) Pub. Date: Sep. 3, 2026

(54) A SYSTEM FOR MOVING OBJECTS SUITABLE FOR A ROBOTIC BOARD GAME

(71) Applicant: PARTICULA LTD., Binyamina (IL)

(72) Inventors: Udi DOR, Binyamina (IL); Amit DOR, Petah Tikva (IL)

(21) Appl. No.: 19/474,129

(22) PCT Filed: Apr. 15, 2024
(86) PCT No.: PCT/IB2024/053687

§ 371 Date: Oct. 9, 2025

Related U.S. Application Data
(60) Provisional application No. 63/459,004, filed on Apr. 13, 2023.

(51) Int. Cl. A63F 3/00; A63F 3/02

(52) U.S. Cl. CPC A63F 3/00643; A63F 3/00574; A63F 3/02; A63F 2003/0063

(57) ABSTRACT

Disclosed herein is a system for moving objects, for example, game pieces. The system includes movable objects and a platform, the platform which can have a game board design. One side of the platform contacts the movable objects. On the other side of the platform, one or more robots use magnetic force to move the objects. A player may use the system to complete with a remote opponent though a network, such as the Internet. Although the opponent is remote, the system displays the opponent's moves by rearranging nearby physical objects on a physical platform near the player.

### RELATED APPLICATION

This application claims benefit under 35 U.S.C. § 119(e) of the Apr. 13, 2023 filing of U.S. Provisional Application No. 63/459,004, which is hereby incorporated by reference in its entirety.

### BACKGROUND

People have enjoyed board games for thousands of years, with evidence of early board games dating back to ancient civilizations, such as those of Egypt, Greece, and Rome. Board games have evolved over time, with the invention of new games and the adaptation of old games to new technologies. Many classic games, such as chess, can now be played online using platforms like provided at chess. com, which offers players many clear benefits. These benefits include access to a wide range of opponents, the ability to learn from tutorials and to analyze games, and the convenience of playing anytime and anywhere. However, playing digitally and digitally online lacks the tactile experience that many players enjoy in traditional board games.

In recent years, the popularity for connected smart toys and games has surged. “Connected” smart toys and games, sometimes known as “app-enabled toys,” can be equipped with electronics that enable communication to external applications (apps), such as through the Internet, for interactive play as well as for competitions with others remotely.

Connected smart toys and games offer unique playing experiences that bridge the “physical” and “digital” worlds, bringing together the best of both worlds. Connected board games, or “connected smart boards,” are a part of this trend. Connected smart boards act as physical interfaces that connect to digital platforms. With the ability to sense players' actions and to monitor their results (such as dice outcomes and specific play movements), the ability to provide audio sounds and visual indications (such as colored lights on the board), and the ability to provide wireless connectivity to external apps (and thus to enable other people to play together), players enjoy a fully immersive playing experience that combines the best of physical and digital worlds.

One of the challenges in creating a fully immersive playing experience for a “local player” competing with a remote player or with an AI (artificial intelligence) machine is how to move board pieces on the local board that correspond to pieces moved by the remote players using a remote board at a remote site or that correspond to moves of the AI machine. For example, when a remote player moves a game piece on a remote board, the corresponding game piece on the local player's board must move the same way. As another example, when an AI opponent makes a “software” move, a corresponding movement on the local board must be executed. While products currently exist that move individual pieces on a game board, their implementations are limited to moving a single piece at a time, making in some cases the gameplay slow and cumbersome.

### SUMMARY

The present disclosure addresses the above-described limitation of the prior art by describing the simultaneous robotic movement of multiple pieces of a connected board game to thereby improve the user experience. This simultaneous game piece movement feature reduces the set-up time for new games (such as for puzzles that start in specific states at specific points and challenge the players to continue from those points), enables multiple movements such as capturing pieces while the capturing and the captured pieces move together, and provides an improved playing experience for games with a remote player or with AI machines. The simultaneous game piece movement feature can also be used for learning, playing, competing, or even replaying and streaming (displaying) other games. Furthermore, people with motor disabilities benefit from this feature, which enables them to play and to enjoy board games with fewer limitations. For example, a player with motor disabilities can audibly indicate a move, and the system will execute it.

Chess is one prime example of a game that a connected robotic board improves. “Traditional” chess is one of the most popular board games, with millions of players worldwide. Chess has been played for centuries and has a rich history and culture. New connected robotic chess boards allow players to compete with other players from around the world or against AI machines. The players can also learn from tutorials and analyze their game play with the comfort of a physical board operated in part electronically. That is, the smart game system provides a fully immersive experience, with the game piece moves of remote players and AI machines exhibited locally on physical boards.

The invention may be embodied as a system for moving objects. The system has movable objects, a platform, and at least one robot. One side of the platform contacts the movable objects. The robot(s) is operative to use magnetic force to move the objects that contact the platform. The robot(s) us located on the side of the platform that is the opposite of the side that contacts the movable pieces.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates features of the invention embodied as a system;

FIG. 2 provides a cutaway view of some of the elements of the system of FIG. 1;

FIG. 3 illustrates how a magnetic is rotated within a robot to vary the magnet field generated thereabove;

FIG. 4 illustrates how an embodiment of a robot remains in contact with the floor of its chamber;

FIGS. 5A and 5B illustrate how an embodiment of a robot remains able to move within a chamber even when its wheel does not retain contact with the floor of its chamber;

FIG. 6 shows how different regions of the chamber may be used for various purposes;

FIG. 7 shows an example of markings on a chamber to assist robot navigation;

FIG. 8 illustrates a sharp turn that the robot is expected to execute;

FIGS. 9A and 9B show before and after, respectively, a robot with a game piece thereabove executes a 90-degree turn with nearly zero turning radius; and

FIG. 10 illustrate the interaction of components enabling a user to compete with a remote opponent.

### DETAILED DESCRIPTION

The invention may be embodied in many ways, as discussed herein.

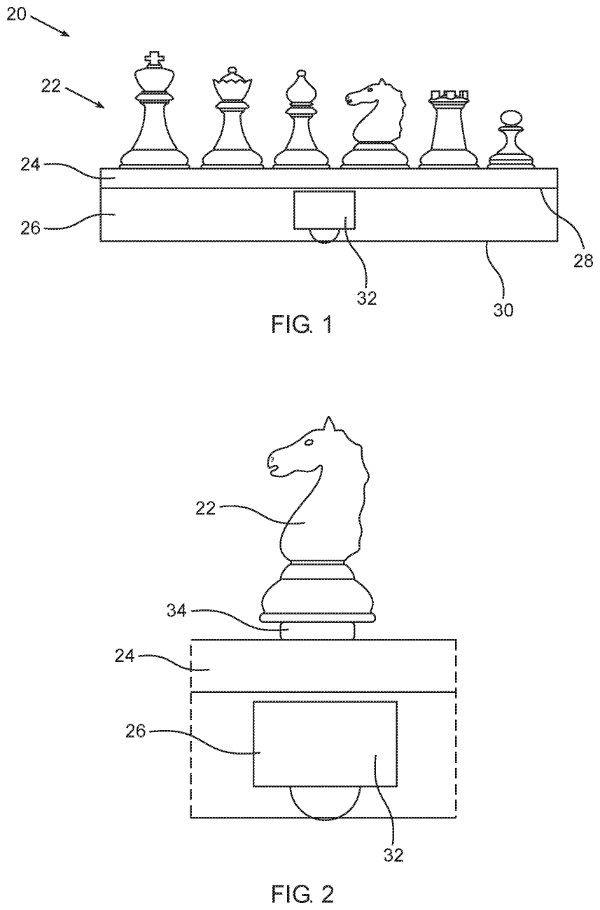

For example, the invention may be embodied as a system 20 for moving objects, as illustrated in FIG. 1. The movable objects in this embodiment are game pieces 22 for chess (chess pieces), and as shown they rest on, thereby contacting, a platform 24 on which the square pattern for a chess board is provided (not visible in FIG. 1.) The system 20 is customizable as alternate embodiments for other games, such as checkers for the movable objects and a checker board design on the platform. Additional alternate embodiments for which the system is adaptable include games such as Monopoly®, Ludo, Chutes and Ladders, and Dungeons & Dragons, as non-limiting examples.

Underneath the platform 24 is a chamber 26 bounded on the top by a ceiling 28 adjacent and in contact with the platform 24. The chamber 26 in this embodiment is bounded on the bottom by a floor 30, which is opposite the platform 24.

The system 20 also includes one or more small robots 32 (only one illustrated in FIG. 1 for clarity), which operate within the chamber 26. The robots 32 use magnetic force to engage the chess pieces 22 through the platform 24 and to move them according to instructions the robots 22 receive from a source internal or external to the system 20. In this embodiment, the robots 32 receive the instructions wirelessly in accordance with the Bluetooth® standard. In alternate embodiments, communications according to other wireless standards, such as infrared, ultrasonic, or radio communications, for example, Wi-Fi, may be implemented. The instructions that the robots 32 receive may be commands to change their positions relative to the platform and to engage or to release a chess piece 22 by increasing or decreasing, respectively, the magnetic force it applies thereto.

That is, the system 20 is not limited to robots that either apply a magnetic force strong enough to engage a game piece 22 or to apply no magnetic force at all to release a game piece. As shown below, the system 20 is versatile and can implement, for reasons such as to drastically reduce costs, robots that reduce the magnetic force on a game piece, not necessarily to zero force, but to a small enough force that allows the robot to release the game piece and then resume moving while the game piece remains at rest. The principle is that the robot has a suitable mechanism that varies the amount of magnetic force it applies to a movable object. Several example implementations are disclosed next, but their equivalents would also be suitable. FIG. 2 illustrates a cutaway view of the chamber 26 with a single robot 32 therein and a single game piece 22 on the platform 24. The game piece 22 has a magnet 34 attached to it on the underside to interact with the magnetic force that the robot 32 applies. Thus, there is no need to create the game pieces out of magnetized or non-magnetized ferromagnetic material.

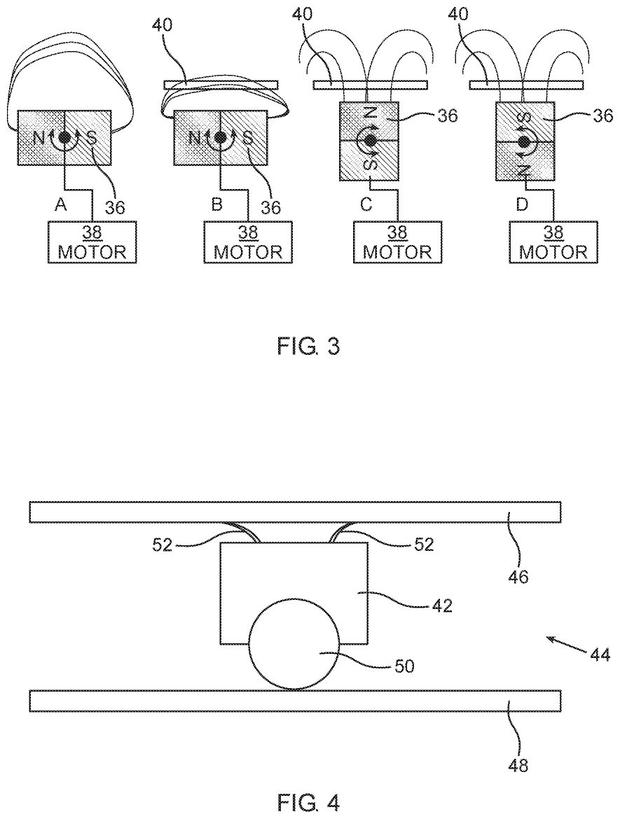

One non-limiting example of a mechanism within a robot that varies the amount of force the robot applies to a game piece is discussed with respect to FIG. 3, which provides illustrations of four orientations, A-D, of a permanent magnet 36 within a robot (the remainder of the robot not shown for clarity). The usage of permanent magnets, as opposed to electromagnets, reduces the power requirements of the system 20.

A motor 38 rotates the magnet 36 about an axis parallel to the plane of the chamber ceiling to place the north and south poles of the magnet closer to or farther from the platform. For each orientations A-D, part of the magnet field is represented by curves for discussion. Accordingly, the field lines for orientation A show the part of the magnetic field that reaches upward.

To confine most of the magnetic field to engage one game piece only, a robot may be equipped with a plate 40 of ferromagnetic metal, such as steel, on its upper side adjacent the platform. With comparison with the illustration for orientation A, the illustration for orientation B shows the magnetic field confined more to the location of a single game piece. Both the orientations A and B of the permanent magnet itself are the same, with both the north and south poles equidistant from where a game piece would be, and it is only the metal plate 40 that causes the difference in magnetic field. Note that, although a plate shape is shown for the ferromagnetic element, other shapes may be implemented to provide the region of ferromagnetic metal on the side of the robot that adjacent the platform, as the use of a different shape or provision of ferromagnetic material does not depart from the spirit and scope of the invention.

In orientation C in the illustrations of FIG. 3 the magnet 36 is shown after the motor 38 rotated it 90 degrees. In this orientation, the north pole of the magnet 36 is closer to the platform and the south pole is farther from the platform. Accordingly, the magnet applies a stronger force to the region where a game piece would rest and can therefore engage it for repositioning. In the present embodiment, the magnet attached to the underside of the game piece has its south pole facing downward.

In orientation D in the illustrations of FIG. 3 magnet 36 is shown after the motor 36 rotated it so that the south pole of the magnet 36 is closer to the platform and the north pole is farther from the platform. This is useful for toppling a game piece using magnet repulsion, such as to show that a remote opponent has decided to forfeit a chess game by toppling his king.

As discussed above, instead using a permanent magnet that rotates to bring its north or south pole closet to or farther from the game as shown in FIG. 3, other mechanisms that vary the amount of magnetic force applied to a game piece may be used. For example, a robot can have a motor and/or circuitry, such as a solenoid, to move a permanent magnet closer to or farther from the game piece, and the movement can be linearly raising the magnet up or lowering it down. Another example mechanism implements an electromagnet in place of a permanent magnet, and the electromagnet is powered as needed to provide the desired magnetic force.

A robot 42 of one embodiment of the invention is illustrated in FIG. 4 inside a chamber 44 between a ceiling 46 and a floor 48. A wheel 50 supports an outer casing of the robot 42 and the contents therein, such as the magnet subsystem discussed above. The robot 42 has another wheel, which is not shown, because it is positioned behind the wheel 50. Both wheels contact the floor 48 to position the robot 48 within the chamber 44 as necessary. The robot 42 may additionally have non-driven wheels or one or more support struts (not shown) to add stability to the robot 42, as to be determined by one skilled in the art. The non-driven wheels would roll freely, and the support strut would freely slide along the floor surface as the robot 42 moves. In alternate embodiments the robot driving system may be implemented with different structure, such as different number of wheels, driving motors and steering mechanisms.

In some embodiments, a robot is designed to be lightweight to reduce power requirements. However, when magnetically engaging a game piece above, the magnetic attraction may tend to lift the robot upward so that the wheels do not contact the floor. Accordingly, in the embodiment of FIG. 4, the robot 42 has leaf springs 52 contacting the chamber ceiling 46 to force the robot casing downward so the wheels 50 remain in contact with the chamber floor 48. In alternate embodiments, instead of using leaf springs to push the robot casing downward, a magnet can be placed in the lower part of the robot casing to couple with another magnet or ferromagnetic material in the chamber floor to pull the robot downward to keep the wheels contacting the floor.

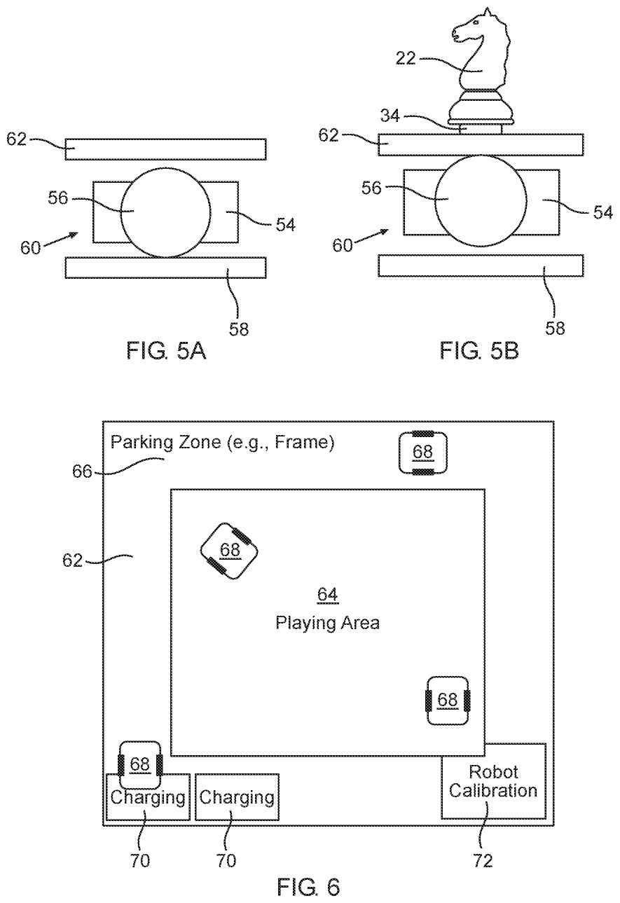

Another embodiment of the robots is illustrated in FIGS. 5A and 5B. In this embodiment, the robot 54 has a casing that has a vertical dimension that is less than the diameter of its wheels 56. The axle (not shown) is positioned relative to the casing such that the wheels 56 extend both further below and further above the casing. Accordingly, when the robot 54 is not in engagement with a game piece, as shown in FIG. 5A, the wheels 56 contact the floor 58, enabling the robot to move within the chamber 60 by driving its wheels, as in the last embodiment. However, when the robot 54 engages a game piece 22, as shown in FIG. 5B, thereby causing the robot 54 to rise, the wheels 56 contact the ceiling 62, enabling the robot to move within the chamber 60 by driving its wheels 56 in the opposite direction.

Various configurations may be implemented to keep the robots stationary when desired instead reacting to environmental factors, such as vibrations in the support provided for the system. One example is for the motors driving the wheels to implement a worm drive gear meshing with a toothed-disc gear affixed around the robot wheel axis, and that would form a self-locking mechanism.

The robot has a positioning and orientation system to determine its location in the chamber and to track its movement in the two dimensions parallel to the plane of the platform. This system enables the robot to advance toward a specific chess piece, to move it along a designated path to a given destination, and to avoid potential collisions or magnetic interactions with other chess pieces on the platform. FIG. 6 provides a top of view of a chamber 62 divided into multiple zones. The chamber 62 has a playing area 64 under which the chess pieces, which are not captured, are positioned. Outside of the playing area 64, for example, surrounding the chess board pattern, may be parking zones 66, where robots 68 can place captured chess pieces thereabove. The chamber 62 also has charging zones 70 for the robots 68 to recharge their batteries. Further, the chamber 62 has a self-calibration zone 72, where for example a robot can measure and calibrate the light reflection from black and white areas for a line-following algorithm and calibrate an optical sensor for reading specific colors, such as red, green, and blue. FIG. 6 provides a top view of an example arrangement for such zones within the chamber 62. Although the image shows individual (standalone) zones for each functionality, in practice some of the zones may overlap so that one zone includes some or all of another zone. For example, the calibration zone may be part of the charging zone.

In some embodiments, the robots continuously measure and calculate their absolute positions within the chamber, their orientations (which way they face in the two dimensions parallel to the platform for the game pieces), and their movements. The robot transmit data accordingly to an external client, in some implementations, to an internal application.

One way the system tracks position and orientation is by embedding an optical sensor within a robot to sense the surroundings. Thus, the robot's absolute position, orientation, and movement is determined. The system may be designed with unique marks, patterns, or other indications on the platform and/or on the floor, walls, and/or ceiling of the chamber to further support the sensing, location determination, and navigation. Example optical sensors for this purpose are RGB sensors, absolute encoders, LASERs, AI-aided cameras, and light detection and ranging (lidar).

An alternate way the system can track robot position and orientation is to embedding sensors inside the chamber to determine a robot's position and to wirelessly communicate the position information to the robot. For example, optical sensors, such as image sensors, can be placed inside the chamber, such as at the four corners, and employ triangulation, in order to determine and report the exact location of each robot in real time.

Another way the system can track a robot's position and orientation is to place sensors on the platform to detect the robot's absolute location beneath it and wirelessly transmit the location information to the robot. Touch sensors, for example, on a touch screen, an array of optical sensors, and capacitive sensors are non-limiting examples of such sensors.

Another way to obtain a robot's absolute position employs “dead reckoning,” that is, knowing the starting location point of a robot and then sensing/measuring robot movement to calculate the new position based on the movement. The starting position may be obtained by employing the techniques described above by retrieval from the internal memory of the system (the last known position data), or through a dedicated calibration process executed by the robot, as well as by a user's inputs from the external app, or by instructing the user (or the factory) to physically place the robot in a specific point (area) inside the chamber while setting up the robots in the product before use.

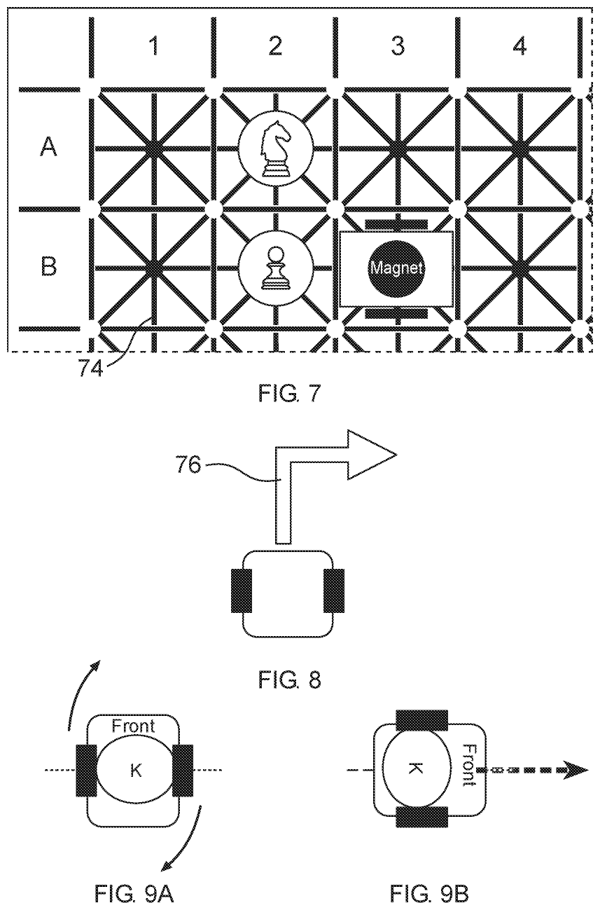

One way to measure differential movement uses optical sensors at the bottom or top of a robot, such as those used for optical mouse computer cursor pointing devices. The system's chamber can have unique pre-defined marks inside, for example, on the floor or on the ceiling, such as bar codes, specific patterns, paths, and color-coded marks, to support and to further simplify monitoring the robot movement. For example, a robot may use simple “line follower” optical sensors while the chamber floor is marked with predefined routes according to game rules. FIG. 7 shows an example of such markings 74. This technique assists the robot in following specific routes with clear junction points that calibrate the robot's absolute position whenever it passes such a junction. Different colors may be used to differentiate specific routes, for example, but distinguishing between left and right and 45-and 90-degree turns.

A combination of the above techniques may be implemented for differential movement for dead reckoning. Also, the exact distance the robot moves can be determined from wheel encoders or stepper motors. Periodically, a robot's absolute position may be calibrated according to predefined anchoring, such as by referencing fixed marks on the chamber floor.

In view of the close proximity game pieces are often have with each other, care is taken in some embodiments to position the magnetic source from a robot on the robot's turning axis. Each robot needs to be capable of moving (driving) two-dimensionally to different locations, and frequently the robot will need to make sharp turns (“on the spot,” meaning that the turning radius is practically zero) to move game pieces along specific routes. FIG. 8 illustrates an example of a sharp 90-degree turn 76, with essentially no turning radius. While such driving systems are known and may be achieved for example by differential driving systems (two independent motors, each driving in different directions), it is often desirable that game piece being moved not make an extraneous move while the robot rotates, which could cause collisions with other game pieces on the platform and maybe even cause movement of pieces to undesired positions on a playing board. Accordingly, in some embodiments the center of a robot's magnet is aligned with the robot's rotational axis, which is between the two wheels in a differential driving system. FIGS. 9A and 9B illustrate a 90-degree turn of game piece K accordingly, FIG. 9A showing before the turn, and FIG. 9B showing after the turn. The result is an almost-zero turning radius of game piece K.

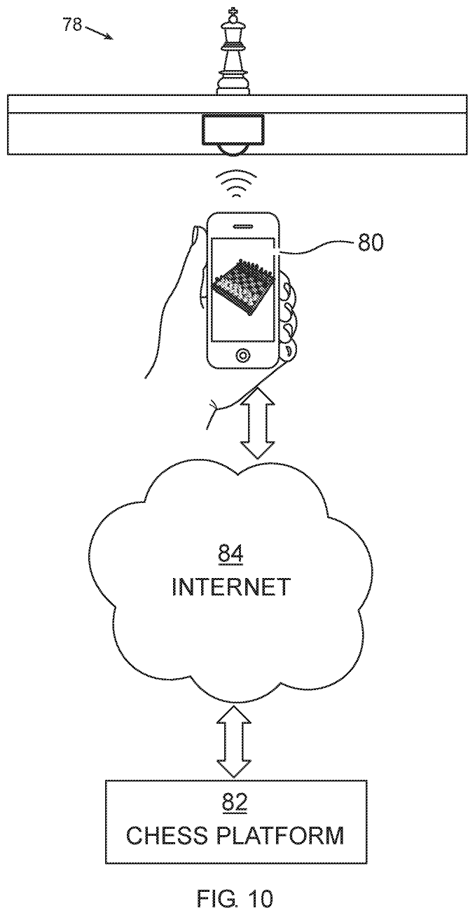

FIG. 10 illustrates a player using a system 78 to compete with a remote opponent. The player interacts wirelessly using a smart phone 80. In this embodiment, the smart phone 80 and system 78 interact using the Bluetooth® standard, but other embodiments may implement other suitable standards. Also in alternate embodiments, instead of smart phone the player can use other clients, such as a personal computer, work station, tablet, or other smart device, as non-limiting examples.

The smart phone 80 interacts with a chess platform 82 through a network, such as, but not limited to, the Internet 84. Examples of such chess platforms are chess.com and lichess.org. examples of alternate networks include home, office, or hotel local area networks (LANs). The player's opponent may be a natural person or an embodiment using artificial intelligence. In some embodiments, the wireless communication may be implemented inside the system (for example, in the platform) and connect directly to the internet (for example, through Wi-Fi) without the need for a smart device as an intervening element.

When playing, the chess platform 82 sends information through the Internet 84 to a software application residing on the player's smart phone 80 indicating how the opponent moved one of his chess pieces. In response, the application sends instructions using the smart phone 80 to the system 78 to instruct the robots how to move the corresponding game piece visible to the player.

The system 78 observes the player's moves and reports them to the application on the smart phone 80, which forwards that information to the chess platform 82. The opponent may have a system similar to the first player's system 78, but this embodiment of the invention is not limited as such.

Implementing the above components and exchanging game piece movement accordingly enables two players separated by a great distance to compete in real time. This embodiment allows the remote communication while still offing the familiarity of watching traditional physical chess pieces move on a physical board.

Embodiments of the invention are not limited to competition requiring communication with an online platform. The system can be equipped with suitable circuity, including a processor and storage, the storage holding instructions that when executed activate the processor to control the at least one robot to move the objects. Artificial intelligence software to act as a player's opponent could therefor reside within the system on that storage. This could be the same storage that host the application needed to send the player's moves to a remote opponent. Another use for this circuitry would be to store moves of a famous or private past game and activate the system to re-enact the game to a user without need to access a network.

Having thus described exemplary embodiments of the invention, it will be apparent that various alterations, modifications, and improvements will readily occur to those skilled in the art. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

1. A system for moving objects, the system comprising:
movable objects;
a platform, one side of which contacting the movable objects; and
at least one robot operative to use magnetic force to move the objects contacting the platform, the at least one robot located on the side of the platform that is opposite the side contacting the movable pieces.

2. The system of claim 1, wherein the at least one robot are multiple robots.

3. The system of claim 1, wherein the at least one robot is configured to receive commands wirelessly for changing its position relative to the platform and for engaging/releasing a movable object.

4. The system of claim 1, wherein the at least one robot has a mechanism that varies the amount of magnetic force it applies to the movable objects.

5. The system of claim 1, wherein the at least one robot has an electromagnet.

6. The system of claim 1, wherein the at least one robot has a permanent magnet and a motor to rotate the magnet to place the north and south poles of the magnet closer to or farther from the platform.

7. The system of claim 1, wherein the at least one robot has a permanent magnet and a motor and/or circuitry to move the magnet closer to or farther from the platform.

8. The system of claim 4, wherein the at least one robot has a region of ferromagnetic metal on its side adjacent the platform.

9. The system of claim 1, wherein the platform has sensors or indications for assisting robot navigation.

10. The system of claim 1, further comprising:
a chamber against the side of the platform opposite the side contacting the movable objects;
wherein the at least one robot operates within the chamber.

11. The system of claim 1, wherein the chamber has sensors or indications for assisting robot navigation.

12. The system of claim 10, wherein the chamber has a ceiling adjacent the platform and a floor opposite the platform, and the at least one robot has at least two wheels that contact the floor to move the robot.

13. The system of claim 12, wherein the at least one robot has a magnet to keep the wheels contacting the floor.

14. The system of claim 12, wherein the at least one robot has a spring forcing the robot away from the ceiling to keep the wheels contacting the floor.

15. The system of claim 10, wherein the chamber has a ceiling adjacent the platform and a floor opposite the platform, and the at least one robot has at least two wheels that contact the ceiling when engaging one of the at least one of the movable objects and that contact the floor when not engaging any of the at least one of the movable objects.

16. The system of claim 1, further including:
circuitry including a processor and storage, the storage holding instructions that when executed activate the processor to control the at least one robot to move the objects.

17. The system of claim 16, where in the instructions, when executed, activate the processor to control the at least one robot to move the objects based at least in part on input provided from a source external to the system.

18. The system of claim 1, wherein instructions provided from outside the system control the at least one robot to move the objects.

19. The system of claim 9, wherein the at least one robot has an optical sensor to see the indications on the platform or on the chamber for navigation.

20. The system of claim 1, wherein:
the movable objects are game pieces; and
the surface of the platform contacting the game pieces has a game board pattern thereon.
